(19) United States
(12) Patent Application Publication
(10) Pub. No.: US 2005/0138267 A1
(43) Pub. Date: Jun. 23, 2005

(54) Integral memory buffer and serial presence detect capability for fully-buffered memory modules

(76) Inventors: Kuljit S. Bains, Olympia, WA (US); Robert M. Ellis, Hillsboro, OR (US); Chris B. Freeman, Portland, OR (US); John B. Halbert, Beaverton, OR (US); Michael W. Williams, Citrus Heights, CA (US)

Correspondence Address: MARGER, JOHNSON & MCCOLLOM, P.C. - INTEL, 1030 SW MORRISON ST., PORTLAND, OR, 97205, US

(21) Appl. No.: 10/746,948

(22) Filed: Dec. 23, 2003

(51) Int. Cl. G06F 12/16

(52) U.S. Cl. 711/100

(57) ABSTRACT

Method and apparatus for use with buffered memory modules are included among the embodiments. In exemplary systems, a serial presence detect function is included within a memory module buffer instead of being provided by a separate EEPROM device mounted on the memory module. Various embodiments thus can provide cost savings, chip placement and signal routing simplification, and can in some circumstances save pins on the module. Other embodiments are described and claimed.

### FIELD OF THE INVENTION

This present invention relates generally to digital memory systems, components, and methods, and more particularly to memory module buffers containing a serial presence detect capability.

### BACKGROUND

Digital processors, such as microprocessors, use a computer memory subsystem to store data and processor instructions. Some processors communicate directly with memory, and others use a dedicated controller chip, often part of a “chipset,” to access memory.

Conventional computer memory subsystems are often implemented using memory modules. Referring to FIG. 1, a processor 20 communicates across a front-side bus 25 with a memory controller/hub (MCH) 30 that couples the microprocessor 20 to various peripherals. One of these peripherals is system memory, shown as dual inline memory modules (DIMMs) D0, D1, D2, and D3 inserted in card slots 52, 54, 56, and 58. When connected, the memory modules are addressed from MCH 30 whenever MCH 30 asserts appropriate signals on an Address/Control Bus 50. Data transfers between MCH 30 and one of the memory modules occur on a Data Bus 40. Buses 40 and 50 are referred to as “multi-drop” buses due to their use of multiple bus stubs, one for each memory module.

An I/O channel hub (ICH) 60 also communicates with MCH 30 across a hub bus 35. Various peripherals can connect to I/O channel hub 60 across a Low Pin Count (LPC) bus 68, System Management Bus (SMBus) 65, and a Peripheral Component Interconnect (PCI) bus (not shown). LPC bus 68 connects to a Basic Input/Output System (BIOS)/firmware hub 70 that supplies boot code and other low-level functions for the system.

SMBus 65 provides a low-bit-rate serial channel that is used for simple functions such as battery and power management, turning off/on LEDs, and detecting the presence of some components. SMBus 65 conforms, e.g., to System Management Bus (SMBus) Specification, Version 2.0, SBS Implementers Forum, Aug. 3, 2000. I/O channel hub 60 contains an SMBus master that can drive the serial clock (SCL) and serial data (SDA) SMBus lines to read and write to other SMBus devices, and the system also provides 3.3 V (VCC) and ground (GND) power connections for the SMBus devices.

In this prior art system, each memory slot contains couplers for the four SMBus lines SDA, SCL, and for three hardwired address lines A2, A1, and A0. The hardwired address lines assert a different combination of high/low signals to each card slot: binary 000 to slot 0 (connector 52), binary 001 to slot 1, binary 010 to slot 2, and binary 011 to slot 3.

FIGS. 2A and 2B exemplify how the four SMBus lines and three hardwired address lines are connected on a DIMM. FIG. 2A shows that DIMM D0 (and each other DIMM) contains a Serial Presence Detect (SPD) electronically erasable programmable read-only memory (EEPROM) device 100. FIG. 2B focuses on the right end of DIMM D0, showing exemplary connections for SPD EEPROM 100 (the signal routing traces and connector assignments shown in FIG. 2B are not intended to correspond to any actual device arrangement). An eighth connector WP receives a write protect signal that can be used to disable or enable writes to SPD EEPROM 100—this connector may be unnecessary when the WP package pin on SPD EEPROM 100 is tied directly to VCC, which serves to disable all writes to EEPROM 100 and thus protects the data stored in the EEPROM.

FIG. 3 contains a block diagram for a representative SPD EEPROM 100, an ATMEL 24C02 available from Atmel Corporation, San Jose, Calif. Start/stop logic 110 examines the SCL and SDA SMBus signals to determine when a bus master asserts a start or stop condition on the SMBus. Serial control logic 120 receives SCL, SDA, WP, and start/stop condition signals, and uses these to coordinate the operation of various other parts of the EEPROM. For instance, when a start condition occurs, serial control logic 120 asserts LOAD to a device address comparator 130, causing comparator 130 to load a device address from SDA and compare that address to a binary device address 1010[A2][A1][A0]. When an address match occurs, serial control logic 120 determines whether a read or write command is signaled, and asserts appropriate enable commands to write circuitry 172, data word address/counter 140, and Dout/ACK logic 180.

Data word address/counter 140 drives an X decoder 150 and a Y decoder 160, which in turn select an eight-bit location in an EEPROM core 170 using a sense amplifier/multiplexer 174. Data word address/counter 140 can be loaded with a newly-supplied address for each operation (using LOAD), or can be incremented from the last-used address for consecutive read operations (using INC).

Dout/ACK logic 180 drives SDA under two conditions. The first condition is to acknowledge data received from a SMBus master. The second condition it to serialize and drive data read from EEPROM core 170 in response to a read request from a SMBus master.

At the factory that assembles DIMM D0, EEPROM core 170 is loaded with parameters describing the configuration, size, timing, and type of DIMM. When the system of FIG. 1 starts up, processor 20 vectors to an address that accesses basic startup code from hub 70 and then configures itself. Processor 20 then causes ICH 60 to address each SMBus DIMM slot, and, if a DIMM is inserted in that slot, to read memory parameters from that DIMM's SPD EEPROM. Processor 20 configures MCH 30 according to the retrieved DIMM parameters. The boot sequence can then proceed with MCH 30 and the inserted DIMMs fully operational.

### BRIEF DESCRIPTION OF THE DRAWINGS

The embodiments may be best understood by reading the disclosure with reference to the drawing, wherein:

FIG. 1 illustrates a prior art computer system;

FIGS. 2A and 2B show a prior art DIMM;

FIG. 3 contains a block diagram for a prior art SPD EEPROM;

FIG. 4 depicts a computer system incorporating fully-buffered DIMMs according to some embodiments of the present invention;

FIG. 5 shows the general physical device layout for fully-buffered DIMMs according to some embodiments of the present invention;

FIG. 6 contains a block diagram for a memory module buffer according to some embodiments of the present invention;

FIG. 7 contains a block diagram for a memory module buffer package incorporating an SPD EEPROM integrated circuit in the buffer package, according to some embodiments of the present invention;

FIG. 8 contains a block diagram for a memory module buffer, according to some embodiments of the present invention, that uses a single SMBus controller to access an SPD nonvolatile memory block and a built-in self-test function;

FIG. 9 depicts a computer system incorporating fully-buffered DIMMs according to some embodiments of the present invention, wherein slot addresses are not hardwired but are determined at startup using the system's memory channels; and

FIG. 10 contains a block diagram for a memory buffer, according to some embodiments of the present invention, useful for instance in the computer system of FIG. 9.

### DETAILED DESCRIPTION OF THE EMBODIMENTS

This description pertains to “fully-buffered memory modules,” which differ from standard DIMMs is several respects. Primary among these differences is the presence on the memory module of a memory module buffer that isolates the memory devices on the module from the memory channel that connects the module to an MCH (or processor). In the embodiments described below, an SPD function is combined with the memory module buffer.

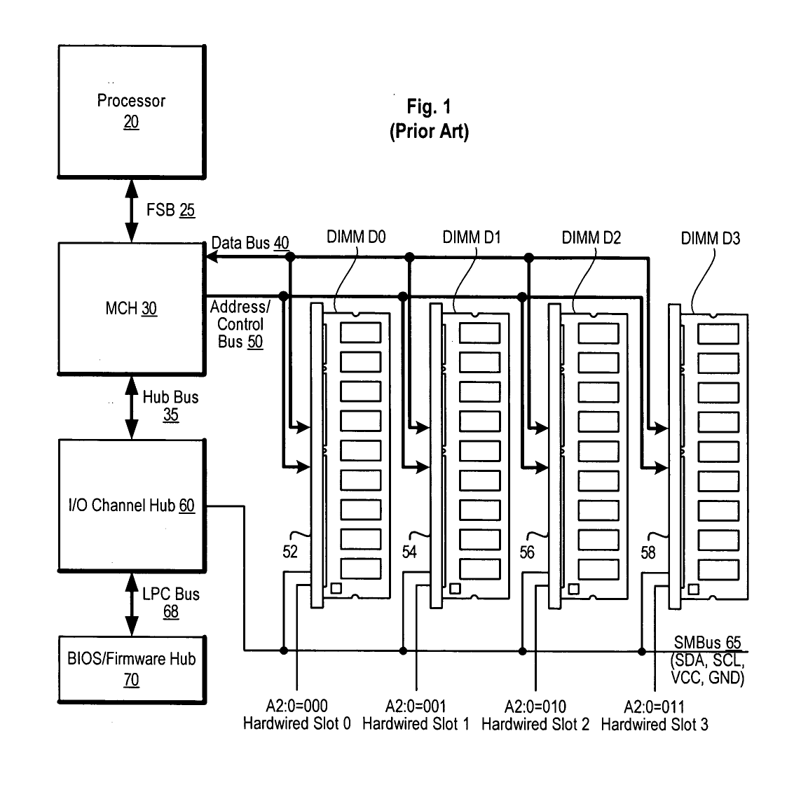

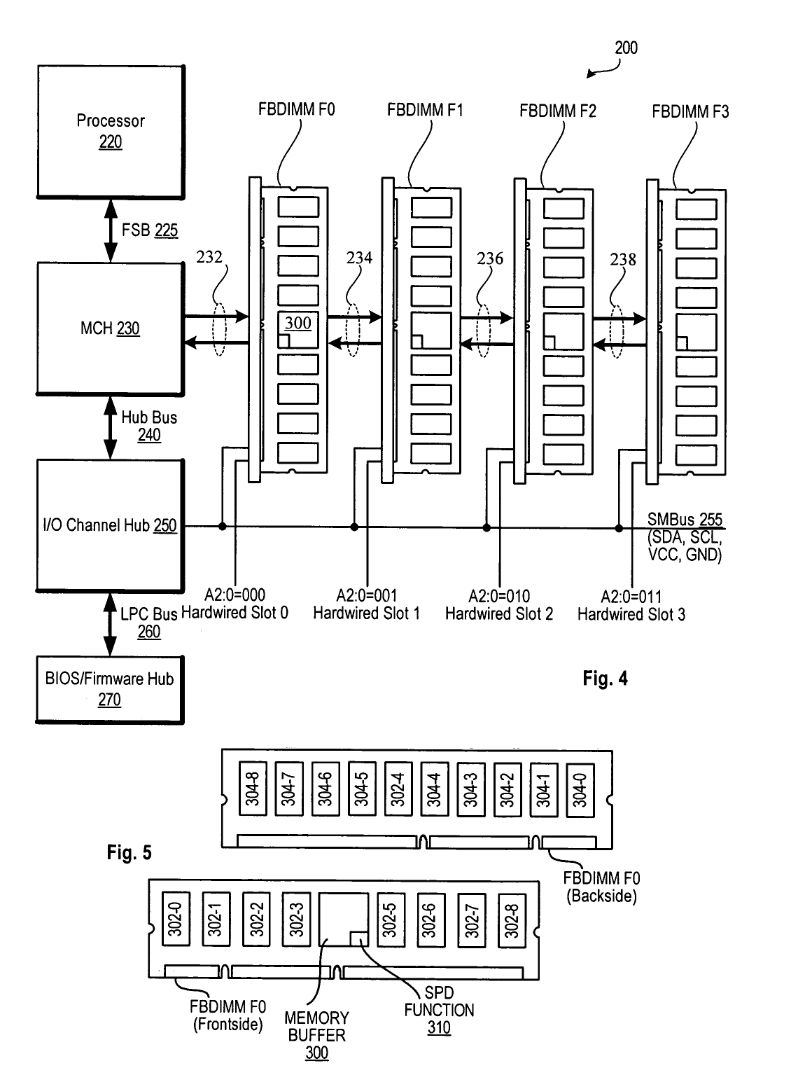

Referring first to FIG. 4, a system 200 incorporating a buffered-memory-module memory subsystem 200 is shown, comprising a processor 220, front-side bus 225, MCH 230, hub bus 240, I/O channel hub 250, SMBus 255, LPC bus 260, and BIOS/firmware hub 270, interconnected as their counterparts in FIG. 1 are connected and functioning similarly in large part. MCH 230 does not use a multi-drop address/control bus and multi-drop data bus as in FIG. 1, however. Instead, MCH 230 communicates with a memory module buffer 300 on fully-buffered DIMM (FBDIMM) F0 over two opposing unidirectional point-to-point bus connections that together function as a memory channel 232. In some embodiments, memory channel 232 uses a relatively low number of high-bit-rate differential signaling pairs to link MCH 230 to FBDIMM F0. Since each differential pair serves a unidirectional point-to-point dedicated connection, with no stubs or “multiple drops”, high bit rates can be sustained.

FBDIMM F1 does not connect directly to MCH 230, but instead connects to buffer 300 of FBDIMM F0 over a second memory channel 234 that functions identically to memory channel 232. As will be explained shortly, buffer 300 shuttles traffic between memory channels 232 and 234 to facilitate MCH communication with FBDIMM F1.

Many, or a few, FBDIMMs can be connected to an MCH using this point-to-point memory channel configuration. In FIG. 4, four FBDIMMs are shown, with an FBDIMM F2 connecting to FBDIMM F1 through a third point-to-point memory channel 236, and an FBDIMM F3 connected in turn to FBDIMM F2 through a fourth point-to-point memory channel 238.

Buffered memory module F0 is typical of the memory modules. FIG. 5 shows both a frontside view and a backside view of FBDIMM F0. The frontside of FBDIMM F0 includes memory buffer 300 and eight DRAM (Dynamic Random Access Memory) devices 302-0 to 302-8. The backside of FBDIMM F0 includes ten DRAM devices, including a DRAM device 302-5 that is part of the memory rank 302-0 to 302-8, and a second rank of memory 304-0 to 304-8.

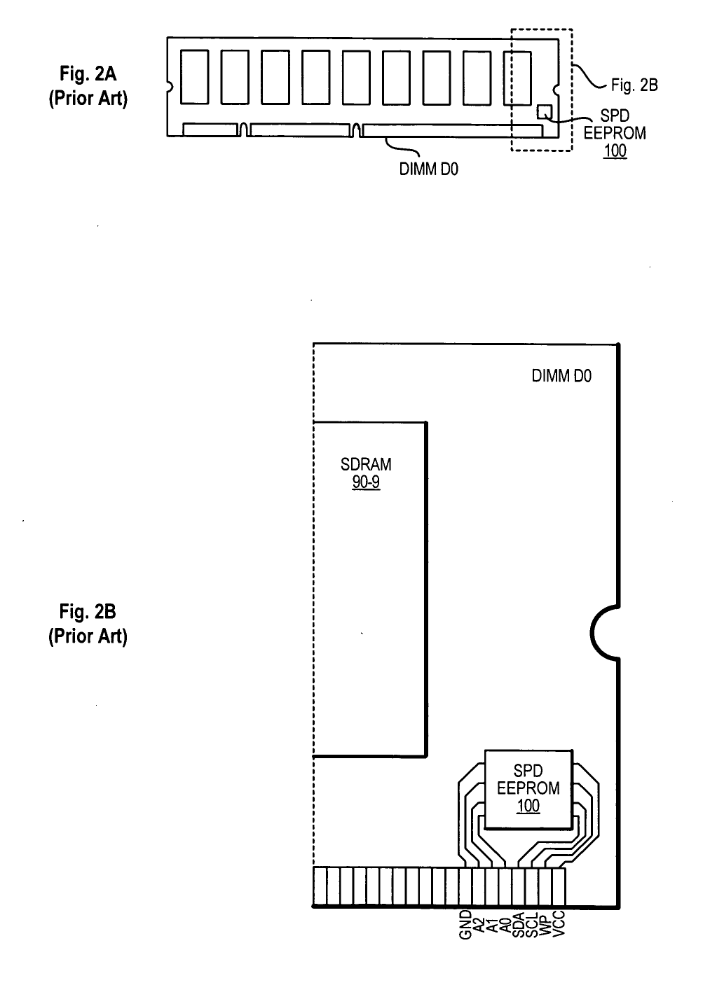

An SPD function 310 is included in buffer 300, instead of in a dedicated device package mounted on a DIMM circuit board as shown in FIGS. 2A and 2B. In at least some embodiments, the SPD function can be implemented in what would otherwise be unused silicon on the relatively large buffer integrated circuit die, reducing the chip count for the module and potentially resulting in cost savings. Removal of the dedicated SPD package found on prior art DRAM devices can also remove some constraints on where DRAM devices (e.g., 302-8) can be placed on the DIMM, as well as constraints on where DRAM bus lines can be routed from buffer 300 to the DRAM devices. Further, a SMBus connection to the buffer circuit is desirable in some circumstances for functions other than SPD, and thus at least the SMBus package pins can be shared between these other functions and the SPD function in such cases.

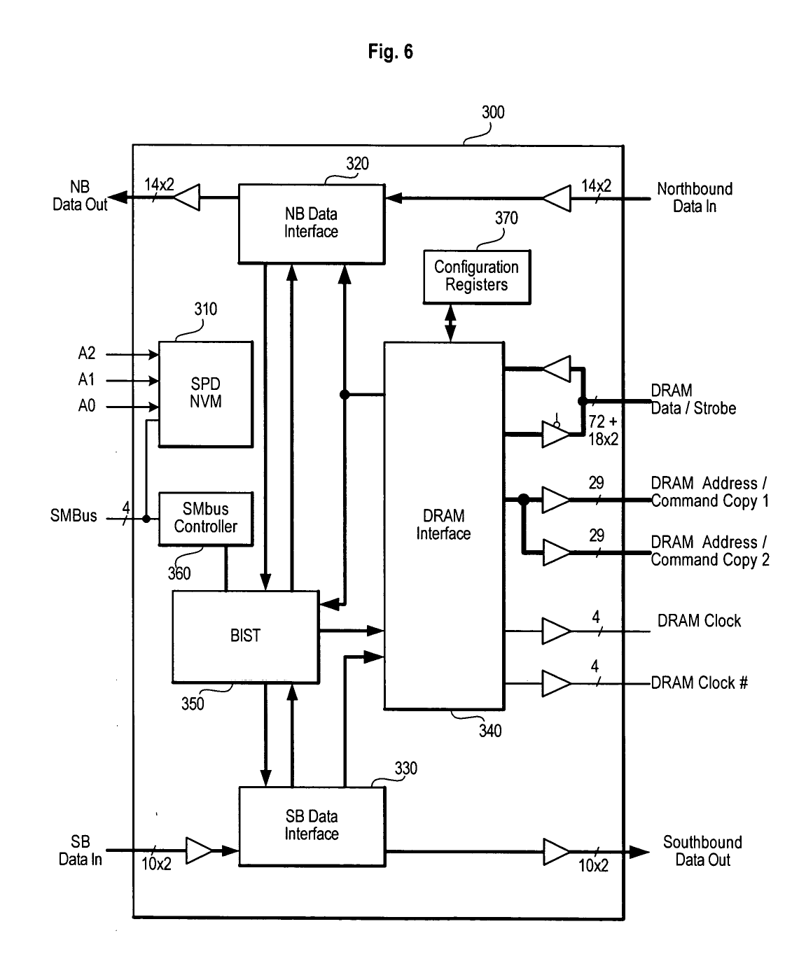

FIG. 6 contains a block diagram for memory module buffer 300. The primary blocks of the buffer are an SPD nonvolatile memory (NVM) function 310, a northbound (NB) data interface 320, a southbound (SB) data interface 330, a DRAM interface 340, a built-in self test (BIST) function 350, an SMBus controller 360, and a set of configuration registers 370.

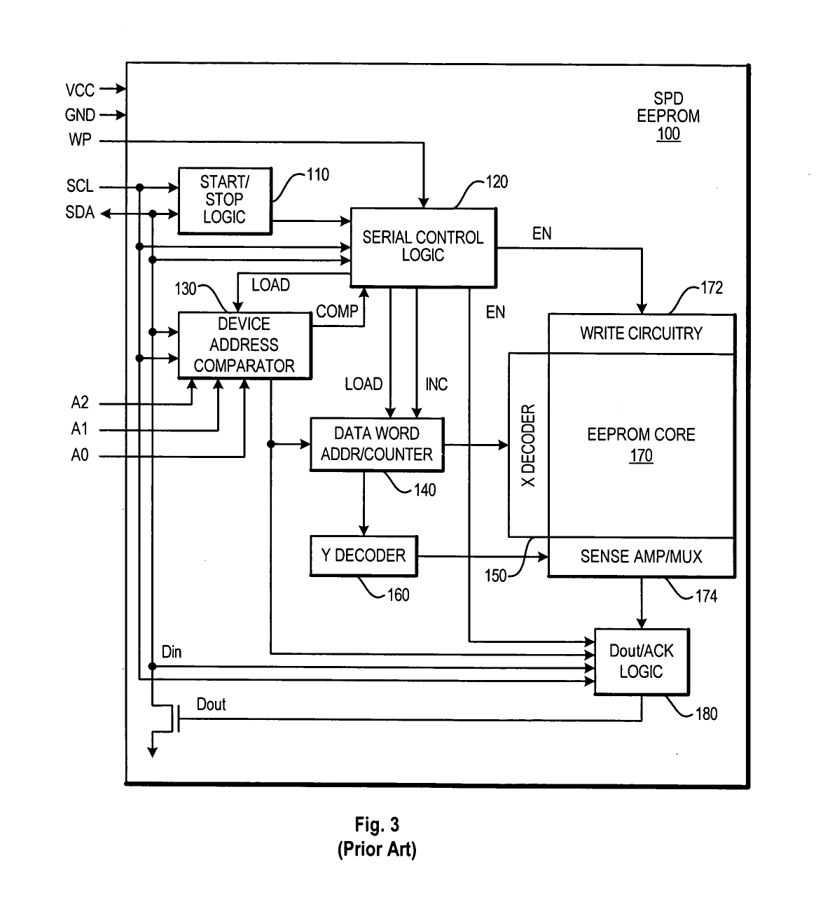

SPD NVM 310 and SMBus controller 360 receive the four SMBus signal/power lines. In addition, SPD NVM 310 receives the three hardwired address assignment signals A2, A1, and A0. SPD NVM 310 uses the three address assignment signals to determine its SMBus address, e.g., as previously described for the SPD EEPROM of FIG. 3. Although SPD NVM 310 could potentially be configured as an EEPROM as shown in FIG. 3, the key elements of SPD NVM 310 are a nonvolatile memory area, which typically only needs to be programmed once, and a SMBus controller that allows the nonvolatile memory area to be accessed over the SMBus connection. Thus the nonvolatile memory area could be an array of conventional flash memory cells, a PROM (programmable read-only memory) array, an EPROM (erasable PROM) array, or a set of laser-severable fuses. In some cases where a high enough volume of FBDIMMs with a similar configuration are to be produced, the nonvolatile memory area could even comprise a masked ROM array that is programmed during semiconductor fabrication, with different ROM masks being used for buffer circuits serving different FBDIMM configurations.

A southbound data path comprises a host-side memory channel SB data input and a downstream memory channel SB data output that normally redrives the differential signals received at the SB data input. A SB data interface 330 passes buffer commands and data received at the SB data input to a DRAM interface 340, and potentially to BIST 350. In test modes, BIST 350 can also provide signals to SB data interface 330 to be driven on the southbound data output.

A northbound data path comprises a downstream memory channel NB data input and a host-side memory channel NB data output that normally redrives the differential signals received at the NB data input. A NB data interface 320 allows the DRAM interface 340 to interject data read from a module's DRAMs onto the northbound data output. In test modes, BIST 350 can also interject data onto the northbound data output or read data from the northbound data input.

The DRAM interface 340 communicates with the narrow high-speed NB and SB data interfaces on one side and with the wider, slower DRAM interface on the other side. DRAM interface 340 contains logic to translate commands received at the SB data input port into properly-timed DRAM addresses and commands, to buffer write data received at the SB data input port for writing to a module's DRAM devices, and to buffer read data received from a module's DRAM devices for transmission out the NB data output. A memory controller or processor can transfer parameters, e.g., those read from SPD NVM 310, to a set of configuration registers 370 using the SB data in port. The configuration register parameters can then be used to adjust how DRAM interface 340 communicates with a rank or ranks of DRAMs on the module.

BIST function 350 can initiate test sequences to test the device's memory channels and/or test the DRAM devices. In the illustrated embodiment, a SMBus controller 360 connects to BIST function 350. A remote SMBus master (e.g., a processor operating through an ICH) can initiate BIST functions and/or gather BIST results by issuing SMBus commands to SMBus controller 360. SMBus controller 360 can have a dynamic address assigned by the system.

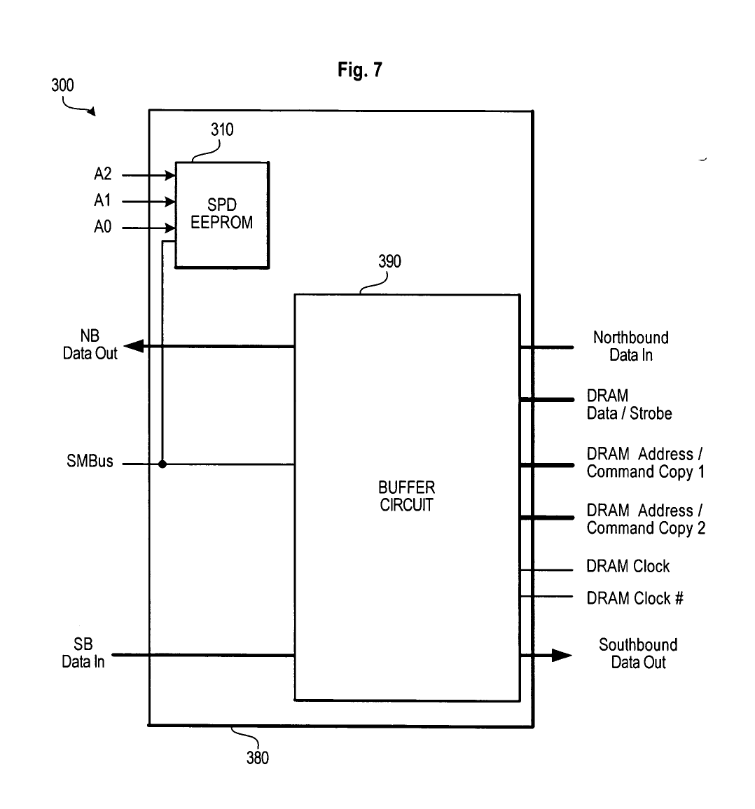

FIG. 7 shows an alternate type of embodiment for memory module buffer 300. In this embodiment, an SPD EEPROM die 310 and a buffer circuit die 390 are mounted in a common package 380. The buffer circuit die 390 contains, e.g., the functions just described for the buffer of FIG. 6, except for the SPD function. The SMBus connections can still be shared between die 310 and 390 internal to the package, such that a single set of SMBus pins appear external to the package.

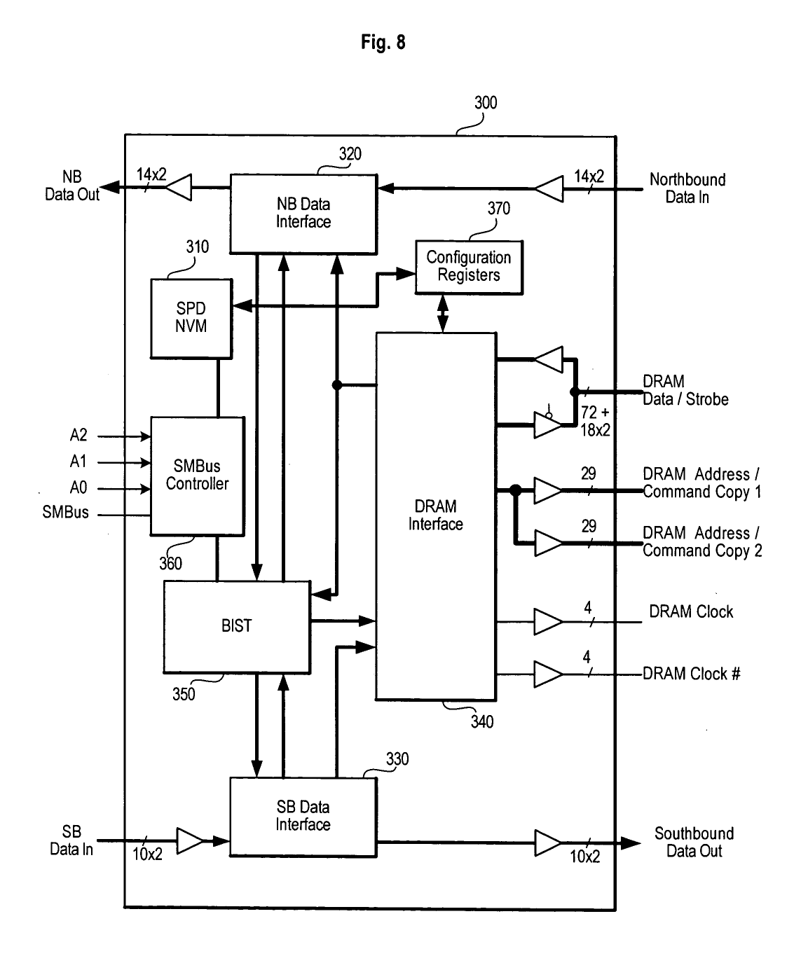

FIG. 8 shows yet another alternate type of embodiment for memory module buffer 300. In this embodiment, a single SMBus controller 360 recognizes two SMBus addresses—one for addressing the SPD nonvolatile memory 310, and another for addressing BIST function 350. Much of the SMBus controller circuitry can be shared between the two functions, with two address comparators used to select the appropriate target function. Also, another variation shown in FIG. 8 is a connection directly from SPD NVM 310 to configuration registers 370, allowing configuration registers 370 to be loaded directly with SPD parameters, without the intervention of the ICH, MCH, and processor.

In an alternative group of embodiments, SMBus controller 360 can accept a single SMBus address related to both SPD NVM 310 and BIST 350. SPD NVM 310 and BIST 350 are assigned different ranges of memory addresses. Depending on the current data address in SMBus controller 360, controller 360 determines whether a received SMBus command targets SPD NVM 310 or BIST 350. The addresses assigned to BIST 350 could constitute a memory array (volatile or non-volatile), or be translated to access a group of BIST registers.

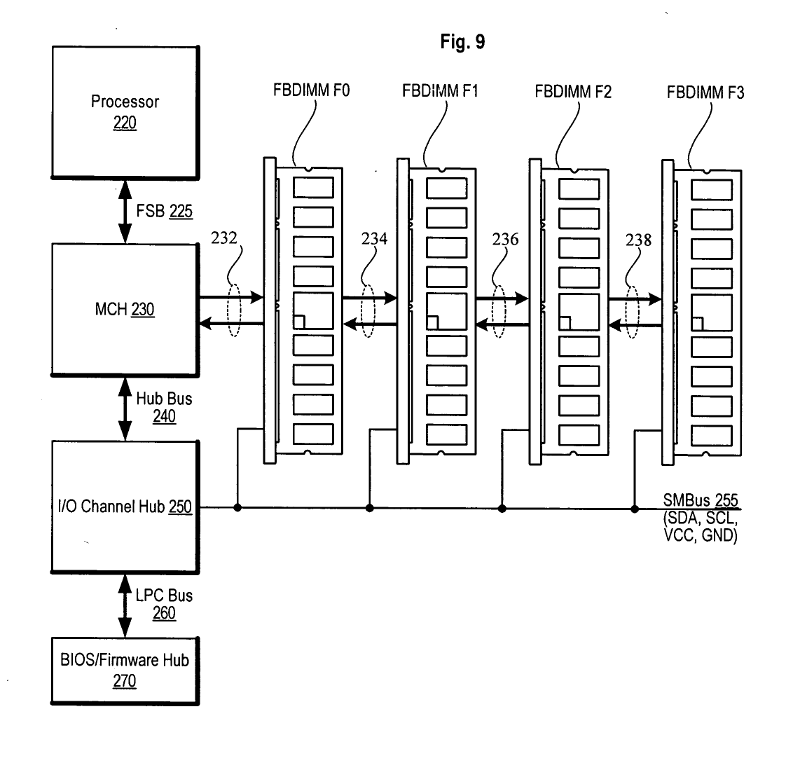

With some embodiments of the point-to-point memory channel arrangement, an opportunity may also exist to do away with the hardwired slot address scheme shown in FIGS. 1 and 4. Without a requirement for hardwired A2, A1, and A0 lines, three pins on each FBDIMM connector on each FBDIMM and three pins on each memory module buffer can be saved, and the requirement of FIG. 1 that the system motherboard contain hardwired address lines for each memory slot can go away as well. FIG. 9 shows such an arrangement. In this type of embodiment, MCH 230 and FBDIMM F0 support a memory channel mode, on channel 232, that allows at least some commands to be sent to the FBDIMM over memory channel 232 during link setup and before the FBDIMM buffer is fully configured. For instance, MCH 230 can send a memory slot assignment token to FBDIMM F0 over channel 232. FBDIMM F0 will read this token, but it will also be redriven automatically to FBDIMM F1 over memory channel 234, and then to FBDIMM F2 over memory channel 236, etc.

Each memory module buffer receiving such a token can take one of several possible actions. For instance, a second copy of the token can be sent downstream by each module buffer receiving the first token. Each module buffer can thus count the number of tokens it receives to determine which slot it resides in. Alternately, each module buffer can increment the token and pass a copy. The token value of the last assignment token received by a buffer indicates the memory slot for that module buffer. Tokens can also be passed in a northbound direction back to the MCH to notify the MCH how many slots contain active FBDIMMs.

Another possibility useful with passed-back tokens is a scheme where each module disables its ability to propagate southbound data out signals until it has received a slot assignment token indicating its slot position. Once such a token is received by the memory module buffer of FBDIMM F0, the slot assignment address from the token is noted, the token is passed back to the MCH, and the buffer on FBDIMM F0 enables its southbound-data-in-to-southbound-data-out path. When the MCH sends a second token (with a second assignment address), it will be ignored by FBDIMM F0 but resent over now-enabled memory channel 234 to FBDIMM F1. FBDIMM F1 notes the second slot assignment address, passes the token back to the MCH, and enables its southbound-data-in-to-southbound-data-out path. The process continues until the MCH sends a token that is not returned.

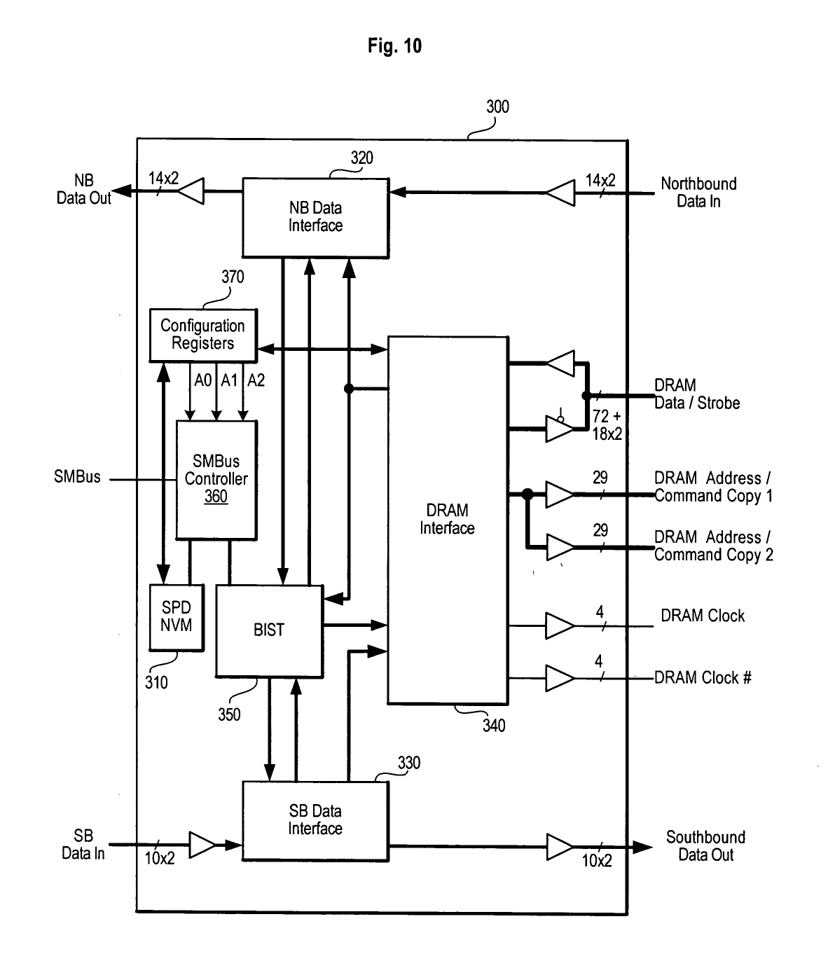

FIG. 10 shows one possible block diagram for a memory module buffer 300 that does not require hardwired slot assignment lines. When a slot assignment is received over the host-side memory channel (for instance by one of the methods described above), the slot assignment is written to a configuration register 370. Configuration register 370 supplies the appropriate slot assignment parameters (e.g., A2, A1, and A0) to SMBus controller 360 without the need for an external hardwired connection. Subsequently, the processor can request SMBus transactions to each FBDIMM memory slot in order to download parameters from SPD NVM 310.

One of ordinary skill in the art will recognize that the concepts taught herein can be tailored to a particular application in many other advantageous ways. In particular, those skilled in the art will recognize that the illustrated embodiments are selected from many alternative implementations that will become apparent upon reading this disclosure. For instance, groupings of buffer functionality other than those described are possible. The particular groupings used herein present one possible functional grouping, but functions can be subdivided and/or combined in many other combinations that fall within the scope of the appended claims.

Many of the specific features shown herein are design choices. Channel and bus widths, signaling frequencies, FBDIMM layouts, number of memory devices, control bus protocols, etc., are all design choices. DIMMs can have multiple ranks of memory and/or memory modules stacks of multiple devices. Although some embodiments have been described using a SMBus as an exemplary serial bus, nothing precludes use of the concepts disclosed herein with other management, control, and/or serial bus formats. A “serial” bus generally uses a single data line or differential line pair for data signaling, but can of course use a small plural number of such connections, as well as ancillary signal lines. Such minor modifications are encompassed within the embodiments of the invention, and are intended to fall within the scope of the claims.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A memory module buffer comprising:
a host-side memory channel interface and a downstream memory channel interface capable of communicating with other devices across memory channels;
a memory device interface coupled at least to the host-side memory channel interface, to communicate with memory devices on a memory module on behalf of a device communicating with the buffer over the host-side memory channel interface;
a serial bus port;
a nonvolatile memory area to store information relating to a memory module served by the buffer; and
a first serial bus controller to transmit information from the nonvolatile memory area out the serial bus port in response to requests received at the serial bus port.

2. The memory module buffer of claim 1, further comprising a second serial bus controller, connected to the serial bus port, to activate memory module buffer functions in response to serial bus commands.

3. The memory module buffer of claim 2, wherein the first serial bus controller responds to a first serial bus address and the second serial bus controller responds to a second serial bus address.

4. The memory module buffer of claim 3, wherein the first and second serial bus controllers comprise at least partially shared common serial bus receiver/driver circuitry.

5. The memory module buffer of claim 1, further comprising a second memory area accessible to both the first serial bus controller and to a self-test function of the buffer, the nonvolatile memory area accessible from the serial bus port using addresses selected from a first range of memory addresses, the second memory area accessible from the serial bus port using addresses selected from a second range of memory addresses.

6. The memory module buffer of claim 1, wherein the first serial bus controller responds to an assigned serial bus address, wherein at least a portion of the assigned serial bus address is supplied to the controller through one of the memory channel interfaces.

7. The memory module buffer of claim 1, wherein the nonvolatile memory area is accessible to the memory device interface through a data channel internal to the memory module buffer.

8. The memory module buffer of claim 7, further comprising a set of configuration registers, wherein the internal data channel is used to mirror information from the nonvolatile memory area to the configuration registers upon startup.

9. The memory module buffer of claim 1, wherein the nonvolatile memory area comprises a plurality of data storage cells selected from the group of storage cell types including masked read-only memory (ROM), programmable ROM, erasable programmable ROM, electronically erasable programmable read-only memory (EEPROM), flash EEPROM, laser-cut fuses, and combinations thereof.

10. The memory module buffer of claim 1, comprising first and second integrated circuits packaged in a common package, wherein the nonvolatile memory area and first serial bus controller are integrated on the first integrated circuit and the memory channel interfaces and memory device interface are integrated on the second integrated circuit, the second integrated circuit further comprising a second serial bus controller, wherein the first and second serial bus controllers both connect to the serial bus port.

11. A buffered memory module comprising:
a plurality of memory devices; and
a memory module buffer coupled to the memory devices, the memory module buffer comprising a serial presence detect function for the module.

12. The buffered memory module of claim 11, wherein the serial presence detect function comprises a nonvolatile memory area containing information related to the memory devices, a serial bus port, and a first serial bus controller to transmit information from the nonvolatile memory area out the serial bus port in response to requests received at the serial bus port.

13. The buffered memory module of claim 12, further comprising a plurality of address assignment lines connected to the first serial bus controller to inform the serial bus controller of a memory slot assignment.

14. The buffered memory module of claim 12, wherein the first serial bus controller responds to a serial bus address at least partially dependent on a memory slot assignment, wherein the memory slot assignment is communicated to the memory module buffer over a memory channel.

15. The buffered memory module of claim 12, further comprising a second serial bus controller connected to the serial bus port, and a built-in self test function, the second serial bus controller providing access between the serial bus port and the built-in self test function.

16. The buffered memory module of claim 12, wherein the memory module buffer comprises first and second integrated circuits packaged in a common package, wherein the nonvolatile memory area and the first serial bus controller are integrated on the first integrated circuit, the memory module buffer further comprising host-side and downstream memory channel interfaces and a memory device interface integrated on the second integrated circuit, the second integrated circuit further comprising a second serial bus controller, wherein the first and second serial bus controllers both connect to a common serial bus port

17. A method of assigning a serial bus address to a serial presence detect function on a buffered memory module, the method comprising:
transmitting a memory slot assignment to the buffered memory module over a memory channel; and
based at least in part on the transmitted memory slot assignment, asserting, internal to the module, an assigned serial bus address to the serial presence detect function.

18. The method of claim 17, wherein transmitting a memory slot assignment to the buffered memory module comprises transmitting a first memory slot assignment token over a first memory channel segment, and receiving the first memory slot assignment token at the buffered memory module.

19. The method of claim 18, further comprising the buffered memory module passing the first memory slot assignment token back along the first memory channel segment.

20. The method of claim 18, further comprising the buffered memory module incrementing a counter in the first memory slot assignment token to form a second memory slot assignment token, and passing the second memory slot assignment token forward along a second memory channel segment.

21. The method of claim 18, further comprising the buffered memory module disabling forwarding out a second memory channel segment of data received on the first memory channel segment until the first memory slot assignment token is received.

22. A computing device comprising:
a processor;
a host memory controller in communication with the processor;
at least a first buffered memory module, comprising a plurality of memory devices, and a memory module buffer coupled to the plurality of memory devices, the memory module buffer having a serial presence detect function;
a first point-to-point memory channel connecting the host memory controller to the first buffered memory module;
a relatively low-speed bus coupled to the first buffered memory module serial presence detect function to allow the processor to discover information related to the memory module configuration.

23. The computing device of claim 22, further comprising:
a second buffered memory module comprising a plurality of memory devices and a memory module buffer coupled to the plurality of memory devices, the second buffered memory module having a serial presence detect function; and
a second point-to-point memory channel connecting the first buffered memory module to the second buffered memory module;
wherein the relatively low-speed bus is also coupled to the second buffered memory module serial presence detect function.

24. The computing device of claim 22, wherein the serial presence detect function on the first memory module comprises a serial bus controller and a nonvolatile memory area accessible through the serial bus controller, the nonvolatile memory area containing information related to the memory devices on that memory module.

25. The computing device of claim 24, the nonvolatile memory area further containing information related to the capabilities of the memory module buffer.

26. The computing device of claim 22, wherein the serial bus controller responds to a serial bus address that is configurable using commands issued to the memory module buffer across the first memory channel.
